(19) United States
(12) Patent Application Publication
(10) Pub. No.: US 2021/0076716 A1
(43) Pub. Date: Mar. 18, 2021

(54) AN EXTRUDED FOOD PRODUCT AND A METHOD OF MAKING THE SAME

(71) Applicant: Virginia Health Food Limited, Co. Cork (IE)

(72) Inventors: Helen O'Dowd, Co. Cork (IE); Christin Schneider, Co. Cork (IE); Irene Gonda, Co. Cork (IE); Agnieszka Glebowska, Co. Cork (IE)

(21) Appl. No.: 16/772,633

(22) PCT Filed: Dec. 14, 2018
(86) PCT No.: PCT/EP2018/084933

§ 371 Date: Jun. 12, 2020

(30) Foreign Application Priority Data
Dec. 15, 2017 (GB) 1721042.8

(51) Int. Cl. A23L 7/17; A23L 7/10; A23L 7/191; A23L 19/00; A23L 33/105; A23L 33/125; A23L 33/15; A23L 33/16; A23L 33/185; A23L 33/115; A23P 30/20

(52) U.S. Cl. CPC A23L 7/17; A23L 7/101; A23L 7/191; A23L 19/01; A23L 19/05; A23L 33/105; A23V 2002/00; A23L 33/15; A23L 33/16; A23L 33/185; A23L 33/115; A23P 30/20; A23L 33/125

(57) ABSTRACT

An extruded food product comprising at least one partially defatted oil seed and an antioxidant.

An extruded food product and a method of making the same.

### FIELD OF THE INVENTION

This invention relates to extruded, textured food products made from an oil seed. Specifically, the invention relates to an extruded textured food product, and a method of making the same, wherein the food product comprises flaxseed or hemp seed, an antioxidant and other nutraceuticals, in which the components are contained within the food product.

### BACKGROUND TO THE INVENTION

There is a gap in the traditional breakfast cereal, health bar and healthy snack market for healthier, nutrient-dense options, which are also low in sugar, have no added refined sugar, are high in fibre and protein and provide a source of alpha-linolenic acid (ALA) or plant-based Omega-3. In addition, the majority of the high protein cereals, bars, and snacks on the market are based on soya, wheat or dairy, all of which are included in the list of the top 14 allergens which must be declared in the European Union (EU) and the eight most common allergenic foods considered by the US. Wheat fibre, which is used extensively in extruded breakfast cereals, while cheap, can be poorly tolerated by consumers who suffer from wheat intolerance or Irritable Bowel Syndrome (IBS) symptoms.

Currently, the demand for plant proteins is growing from concerns associated with both health and sustainability. The majority of the plant-based proteins, apart from soya, such as pea protein, lentil protein, sunflower seed protein, rice protein, hemp protein, linseed protein etc. are available in powder form only. These must be mixed with water, juice, milk etc. before consumption, and tend to be grainy or gritty in texture with poor solubility. As a result, their acceptability is poor and their end use applications are limited in cereals, cereal bars and snacks, having disadvantages in term of texture, flavour and ease of processing. If they are extruded using particular formulations and under certain conditions of high-pressure extrusion, their acceptability and end use application is enhanced. However, oil seeds such as linseed and hempseed, while being among the most nutritious of oilseeds, have not been used as ingredients in extruded products due to their high content (up to 40%) of highly unsaturated fats, which are sensitive to oxidation and flavour deterioration under the processing conditions used for extrusion.

EP Application No. 1937082 discloses combining soy protein and a wheat protein with water, and extruding the mixture under heat and high pressure to produce a high-protein food product. The food product typically has 70 wt % protein and wheat gluten as the preferred additional protein source. International Pamphlet Publication WO 2014/138451 discloses a method for producing a high-protein crisp product by mixing a hydrolysed protein (soy protein isolate) and a Group I or Group II metal (Ca, Mg, Na), and extruding the mixture to form the crisp. International Pamphlet Publication WO 2013/131895 describes an extruded cereal piece of wheat, rice or corn, with a covering layer of flaxseed. CN104286085 describes a baked product, a bread, for weight loss, relieving constipation and like that. US2009181147A1 also describes a baked product that requires baking powder to aerate the product to make it lighter and they use powdered flax meal in the formulations. FR2981543 describes the manufacture of buckwheat ‘wafers’ with powdered flax meal made from the flaxseed cake that is a by-product of the flax oil expeller process. WO 2001/074169 describes baking biscuits.

It is therefore an object of the present invention to overcome at least one of the above-mentioned problems.

### SUMMARY OF THE INVENTION

Broadly, the present invention is based on an extruded food product comprising flaxseed (linseed) and/or hempseed raw materials. Additional ingredients include rice flour, an antioxidant and other nutraceuticals. The product is high in protein, high in fibre and high in omega-3 fatty acids (ALA). The product is gluten free, soy and dairy free, neutrally flavoured and provides great texture to any bar, cluster, cereal or snack application. It has a shelf life of a minimum of 12 months from production when stored at ambient temperatures. The fibre from flaxseed and hempseed is much gentler on the gastrointestinal tract and is well tolerated by most consumers.

According to an aspect of the present invention, there is provided, an organoleptically acceptable extruded food product comprising at least one partially defatted oil seed, a gluten-free, high-starch flour, and an antioxidant.

Preferably, the at least one partially defatted oil seed is selected from flaxseed, hemp seed, pumpkin seed, sunflower seed, chia seed or a combination thereof.

Preferably, the at least one partially defatted oil seed is in powder form.

Preferably, the flour is selected from rice flour, lentil flour, potato flour, cornflour, tapioca flour, coconut flour, oat flour or a combination thereof.

Preferably, the antioxidant is selected from rosemary extract, mixed tocopherols, cherry extract, vitamin C, acerola (Malpighia emarginata) extract, green tea extract, sage extract, ascorbyl palmitate, 3,5,4′-trihydroxy-trans-stilbene, Mentha spicate extract, turmeric extract and combinations thereof.

Preferably, the product further comprises flavouring, starches, honey, date syrup, raw cane syrup, brown rice syrup, agave syrup, natural sugar replacers, inulin, steviol glycosides, monk fruit, vitamins, minerals, chlorella, spirulina, wheatgrass, barley grass, alfalfa, maca, cocoa, turmeric, herbs and spices and their extracts, natural colouring, botanicals, a freeze-dried component, or a combination thereof.

Preferably, the vitamins are selected from vitamins A, B, B1, B2, B6, B12, C, D, E, or K, Niacin, Pantothenic acid, Folic acid, Biotin, or combinations thereof. Preferably, the minerals are selected from Calcium, Magnesium, Iron, Copper, Iodine, Zinc, Manganese, Potassium, Selenium, Chromium, Molybdenum, Phosphorus, or combinations thereof. Preferably, the freeze-dried component is a fruit or a material derived from a fruit such as strawberry, apple, orange, apricot, grape, peach, pear, berries (raspberry, blueberry, blackberry), mango, melon, banana, citrus fruits, or a combination thereof. Preferably, the freeze-dried component is a vegetable or product made from a vegetable including asparagus, pea pods, peas, broccoli, cauliflower, mixed vegetables, yellow red or green peppers, lotus fruit, celery, garlic, onion, lettuce, carrot, potato, corn or a combination thereof.

Preferably, the at least one partially defatted oil seed is at a concentration of 5-65 wt % (dry weight).

Preferably, the at least one antioxidant is at a concentration of at least 0.01-0.1 wt % (dry weight).

Preferably, the organoleptically acceptable extruded food product described above comprises 5-40 wt % protein, 10-30 wt % fibre and 1-10 wt % alpha-linolenic acid.

The organoleptically acceptable extruded food described above has a shelf life of at least 12 months when stored at ambient temperature.

An organoleptically acceptable extruded food product described above preferably comprises rice flour, partially defatted flaxseed and rosemary extract. Ideally, the organoleptically acceptable extruded food product comprises 39.95 wt % starch (for example, rice flour), 60 wt % partially defatted flaxseed, and 0.05 wt % rosemary extract. Ideally, the organoleptically acceptable extruded food product is further coated with honey, malt syrup or date syrup.

There is provided an organoleptically acceptable extruded food product comprising 30 wt % starch, 50 wt % partially defatted flaxseed, 19.45% pea protein isolate 85%, 0.5 wt % salt, and 0.05 wt % rosemary extract. Preferably, the organoleptically acceptable extruded food product is further coated with honey, malt syrup or date syrup.

There is provided an organoleptically acceptable extruded food product comprising 49.45 wt % starch, 10 wt % partially defatted flaxseed, 10 wt % hemp protein power, 0.50 wt % salt and 0.05 wt % rosemary extract. Preferably, the organoleptically acceptable extruded food product is further coated with malt syrup, honey or date syrup.

Preferably, the organoleptically acceptable extruded food product described is for use in a health bar, baby food, cereal, food topping or pet food.

Preferably, the organoleptically acceptable extruded food product described above has 1-10 wt % alpha-linoleic acid.

There is provided, a method of producing an organoleptically acceptable extruded food product described above, the method comprising the steps of: premixing and dry blending ingredients being used; adding the premixed ingredients to a water stream being fed into an extruder; extruding the product at a temperature of between 100-170° C.; passing the extruded product between a pair of rollers to shape the product; and drying the shaped product in an oven at a temperature of between 100-120° C.

Preferably, the extruded, dried and shaped product is further coated with a syrup or honey following cooling.

In an aspect, the food product is an aerated, textured crisp or can also be considered to be a puffed product.

Preferably, the method further comprises the step of blending the ingredients with additional ingredients selected from seeds, nuts, dried fruits or vegetables. Preferably, the seeds are selected from sunflower seeds, flaxseeds, pumpkinseeds, chia seeds, or a combination thereof. Preferably, the nuts are selected from cashew, almond, walnut, macadamia, peanut, hazelnut, pistachio, pecan, or a combination thereof. Preferably, the dried fruits are selected from strawberry, apple, orange, apricot, grape, peach, pear, berries (blueberry, blackberry), mango, melon, raspberry, banana, citrus fruits, or a combination thereof. Preferably, the vegetable is selected from asparagus, pea pods, peas, broccoli, cauliflower, mixed vegetables, yellow red or green peppers, lotus fruit, celery, garlic, onion, lettuce, carrot, potato, corn or a combination thereof.

Preferably, the method further comprises the step of packaging the extruded product for storage. Preferably, the packaging is hermetically sealed using a modified atmosphere. Ideally, the modified atmosphere is carbon dioxide, nitrogen, or a combination thereof.

In an aspect, there is provided a textured crisp comprising at least one partially defatted oil seed, a gluten-free, high-starch flour, and an antioxidant.

In an aspect, the at least one partially defatted oil seed is selected from flaxseed, hemp seed, pumpkin seed, sunflower seed, chia seed or a combination thereof.

In an aspect, the at least one partially defatted oil seed is in powder form.

In an aspect, the flour is selected from rice flour, lentil flour, potato flour, cornflour, tapioca flour, coconut flour, oat flour or a combination thereof.

In an aspect, the antioxidant is selected from mixed tocopherols, cherry extract, vitamin C, acerola (Malpighia emarginata) extract, green tea extract, sage extract, ascorbyl palmitate, 3,5,4′-trihydroxy-trans-stilbene, Mentha spicate extract, turmeric extract and combinations thereof.

In an aspect, the textured crisp further comprising flavouring, starches, honey, date syrup, raw cane syrup, brown rice syrup. agave syrup, natural sugar replacers, inulin, steviol glycosides, monk fruit, vitamins, minerals, chlorella, spirulina, wheatgrass, barley grass, alfalfa, maca, cocoa, turmeric, herbs and spices and their extracts, natural colouring, botanicals, a freeze-dried component, or a combination thereof. Preferably, the vitamins are selected from vitamins A, B, B1, B2, B6, B12, C, D, E, or K, Niacin, Pantothenic acid, Folic acid, Biotin, or combinations thereof. Preferably the minerals are selected from Calcium, Magnesium, Iron, Copper, Iodine, Zinc, Manganese, Potassium, Selenium, Chromium, Molybdenum, Phosphorus, or combinations thereof. Ideally, the freeze-dried component is a fruit or a material derived from a fruit such as strawberry, apple, orange, apricot, grape, peach, pear, berries, mango, melon, banana, citrus fruits, or a combination thereof. Preferably, the freeze-dried component is a vegetable or product made from a vegetable including asparagus, pea pods, peas, broccoli, cauliflower, mixed vegetables, yellow red or green peppers, lotus fruit, celery, garlic, onion, lettuce, carrot, potato, corn or a combination thereof.

In an aspect, the at least one partially defatted oil seed is at a concentration of 5-65 wt % (dry weight).

In an aspect, the at least one antioxidant is at a concentration of at least 0.01-0.1 wt % (dry weight).

In an aspect, there is provided a textured crisp described above having 5-40 wt % protein, 10-30 wt % fibre and 1-10 wt % alpha-linolenic acid.

In an aspect, there is provided a textured crisp as described above comprising rice flour, partially defatted flaxseed and rosemary extract.

In an aspect, there is provided a textured crisp comprising 39.95 wt % starch, 60 wt % partially defatted flaxseed, and 0.05 wt % rosemary extract. Preferably, the textured crisp is further coated with honey, malt syrup or date syrup.

In an aspect, there is provided a textured crisp comprising 30 wt % starch, 50 wt % partially defatted flaxseed, 19.45% pea protein isolate 85%, 0.5 wt % salt, and 0.05 wt % rosemary extract. Preferably, the textured crisp is further coated with honey, malt syrup or date syrup.

In an aspect, there is provided a textured crisp comprising 49.45 wt % starch, 10 wt % partially defatted flaxseed, 10 wt % hemp protein power, 0.50 wt % salt and 0.05 wt % rosemary extract. Preferably, the textured crisp is further coated with malt syrup, honey or date syrup.

In an aspect, the textured crisp as described above is for use in a health bar, baby food, cereal, food topping, pet food.

In an aspect, the textured crisp as described above has 1-10 wt % alpha-linoleic acid.

In an aspect, the textured crisp as described above has a Hedonic scale score of greater than or equal to 5.

In an aspect, there is provided a method of producing an textured crisp as described above, the method comprising the steps of: premixing and dry blending ingredients being used; adding the premixed ingredients to a water stream being fed into an extruder; extruding the textured crisp at a temperature of between 100-170° C.; passing the extruded textured crisp between a pair of rollers to shape the textured crisp; and drying the shaped textured crisp in an oven at a temperature of between 100-120° C.

In an aspect, the extruded, dried and shaped textured crisp is further coated with a syrup or honey following cooling.

In an aspect, the method further comprises the step of blending the ingredients with additional ingredients selected from seeds, nuts, dried fruits or vegetables.

In an aspect, the method further comprises the step of packaging the extruded textured crisp for storage. Preferably, the packaging is hermetically sealed using a modified atmosphere. Ideally, the modified atmosphere is carbon dioxide, nitrogen, or a combination thereof.

In an aspect, there is provided a direct expanded extruded food product, the direct expanded extruded food product comprising at least one partially defatted oil seed, a gluten-free, high-starch flour, and an antioxidant. Preferably, the direct expanded extruded food product has a hedonic scale score of greater than or equal to 5.

### Definitions

In the specification, the term “flaxseed” and “linseed” relate to different names for the same seed and can be used interchangeably. The seed is a product of the Flax plant (Linum usitatissimum).

In the specification, the term “extruded” should be understood to mean a process by which a set of mixed ingredients are forced through an opening in a perforated plate or die with a design specific to the food product and is then cut to a specified size by a cutting means, such as blades and the like. The process is carried out under high pressure and high temperature, followed by extrusion under a low-pressure.

The term “food product” should be understood to include comestible products, such as foods and drinks. In particular, the food product is a textured crisp. The textured crisp can be molded as a snack, a health bar, a cereal, a topping for yoghurt, and included in granolas and mueslis for extra texture. The crisp can also be used in baby food, children's snack products and pet foods.

In the specification, the term “textured crisp” should be understood to mean a firm particle of dry food that is light and aerated and which gives a crunch-like sound when bitten or crushed. In other words, the textured crisp is typically an aerated, light and crunchy item which has been direct expanded through a process such as extrusion. These products are also termed extruded direct expanded food products.

In the specification, the term “puffed product” should be understood to mean an extruded food product such as a textured crisp.

In the specification, the term “ambient temperature” should be understood to mean the temperature of the surrounding environment. For example, the ambient room temperature is generally 15° C. to 25° C.

In the specification, the term “partially defatted” should be understood to mean an oil seed, such as flax (linseed) seed or hemp seed, where between 58% and 75% of the fat has been removed from the whole seed product. Partially defatted flax seed is effective in lowering total cholesterol, especially LDL cholesterol. Defatted or partially defatted flaxseed ranges in fat content from 10% to 17% compared with a fat content of 40% in whole flaxseed.

In the specification, the term “starches” should be understood to mean: rice starch, corn starch, potato starch, tapioca starch.

In the specification, the term “flavouring” should be understood to mean substances which are added to food in order to impart or modify its taste and consisting of the following categories, flavouring substances, flavouring preparations, fruit and vegetable extracts, cheese powders and flavourings, meat flavourings, yeast extracts, spice and herb extracts, spices, herbs, oleoresins, thermal process flavourings, smoke flavourings, syrups, sweeteners, etc.

In the specification, the term “vitamins” should be understood to mean nutraceutical additives in the form of Vitamins A, B, B1, B2, B6, B12, C, D, E, K, Niacin, Pantothenic acid, Folic acid, Biotin.

In the specification, the term “minerals” should be understood to mean nutraceutical additives in the form of minerals such as Calcium, Magnesium, Iron, Copper, Iodine, Zinc, Manganese, Potassium, Selenium, Chromium, Molybdenum, Phosphorus.

In the specification, the term “peroxide value” should be understood to mean a measure of the extent to which an oil sample has undergone primary oxidation, that is, the amount of peroxide oxide per kilogram of fat or oil. The unit of peroxide value is milliequivalents (mEq) or millimoles per kilogram.

In the specification, the term “organoleptically acceptable” should be understood to mean that the product receives a Hedonic scale score that is indicative that the product is acceptable to the user via the senses (taste, smell and touch (texture)). Typically, a product with a Hedonic scale score of greater than or equal to 5 is considered to be organoleptically acceptable. When producing the product of the claimed invention, instead of a powder that is gritty and gummy in the mouth, the flaxseed has been transformed into a crispy, crunchy, open-textured, light, snack-type product of low density, which has a fresh, slightly nutty flavour. The product is also free of rancid, grassy or fishy flavours associated with gone-off oils, and with a fresh, clean, slightly cereal odour, that is free of pungent or off notes.

In the specification, the units “wt %” and “w/w” should be understood to mean Xg per 100 g of the composition and can be used interchangeably.

### BRIEF DESCRIPTION OF THE DRAWINGS

The invention will be more clearly understood from the following description of an embodiment thereof, given by way of example only, with reference to the accompanying drawings, in which:—

FIG. 1 is a schematic illustrating the manufacturing process used to make the product described herein.

### DETAILED DESCRIPTION OF THE DRAWINGS

The invention broadly relates to an extruded food product comprising flaxseed (linseed) and/or hempseed raw materials.

### Material and Methods:

Typical ingredients that may be used in the extruded product are, but not limited to, the following:

### Rice Flour (30-60 wt %)

Rice starch (30-60 wt %)
Tapioca starch (30-70 wt %)

### Potato Starch (30-70 wt %)

Partially defatted Flaxseed flour (5-70 wt %)
Partially defatted Hemp seed flour (5-50 wt %)
Pea protein concentrate (10-40 wt %)
Rice protein concentrate: (5-50 wt %)
Pea protein isolate (5-30 wt %)
Oat flour (15-35 wt %)
Lentil flour (10-60 wt %)

### Honey (5-15 wt %)

Malt syrup (5-15 wt %)
Date syrup (5-10 wt %)
Maple syrup (5-15 wt %)

### Salt (0.2-1 wt %)

Steviol Glycosides (20-3300 ppm)

### Sensory Testing

Sensory testing of the products was carried out at 12 months. The results have shown that the products produced were found to be organoleptically acceptable. The 9-point hedonic scale was used to determine acceptability over shelf life for the key attributes: appearance, texture, aroma and flavour and overall liking. Sensory evaluation was undertaken by a trained panel over a number of timepoints throughout a 12-month testing period. Panelist were asked to rate according to their like and dislike using the scale with a score of 9 being “Like Extremely” to a score of 1 being “Dislike Extremely”. A product that scored 5 or greater was considered organoleptically acceptable. Product that scored 4 or under was rejected as unacceptable.

### Storage of Product for Testing

The crisp product produced was stored at ambient temperatures for two years and the product was tested at the end of those two years. For example, the crisp product was tested to determine whether Omega 3 in the product was degraded.

### Compositions

Please note that the units used for the ingredient composition are g/100 g or wt %. Please note that the units used for the product composition are g/100 g or wt %. Please note that the sum of all the parts of the composition make up 100 g or 100 wt % of the composition.

TABLE 1
A typical Extruded Oilseed Crisp recipe contains a combination
of the base three ingredients of a gluten free/high-starch
flour, a partially defatted oil seed and an antioxidant
plus one or more of the other listed ingredients:

| Ingredient | wt % (dry weight) |
|---|---|
| Gluten Free/High-starch Flour | 20-60 |
| Partially Defatted oil seed | 5-65 |
| Protein Source | 5-40 |
| Cereal Flour | 10-40 |
| (Sea) Salt | 0.05-1.5 |
| Antioxidant | 0.01-0.1 |
| Sweetener | 0.1-20 |

Typically, starch or high starch gluten-free flours (such as rice flour), defatted flaxseed and an antioxidant, such as extract of rosemary, green tea extract, sage extract, mixed tocopherols, ascorbyl palmitate, 3,5,4′-trihydroxy-trans-stilbene, Mentha spicate extract, and the like, would form the base ingredients of the recipes described herein.

TABLE 2
An example of a Flaxseed Crisp Recipe

| Ingredient | Amount (wt %) |
|---|---|
| Rice Flour | 39.95 |
| Partially Defatted Flaxseed | 60.00 |
| Extract of Rosemary | 00.05 |

Analysis of the composition in Table 2 revealed a product having 22.8% protein, 20.2% fibre and 8.4% fat content. In accordance with the EC REGULATION No. 1924/2006 OF THE EUROPEAN PARLIAMENT on nutrition and health claims made on foods, the Flaxseed Crisp of Table 2 qualifies for the following claims: High in Fibre, High in Protein, Low in Sugar and High in Omega-3 Fatty Acids.

TABLE 3
An example of a Flaxseed and Pea Protein Crisp Recipe

| Ingredient | Amount (wt %) |
|---|---|
| Rice Flour | 30.00 |
| Partially Defatted Flaxseed | 50.00 |
| Pea Protein Isolate 85% | 19.45 |
| Sea Salt | 00.50 |
| Extract of Rosemary | 00.05 |

Analysis of the composition in Table 3 revealed a product having 33.3% protein, 16.9% fibre and 8.1% fat content. In accordance with the EC REGULATION No. 1924/2006 OF THE EUROPEAN PARLIAMENT on nutrition and health claims made on foods, the Flaxseed Crisp of Table 3 qualifies for the following claims: High in Fibre, High in Protein, Low in Sugar and High in Omega-3 Fatty Acids.

TABLE 4
An example of a Hemp and Flaxseed Crisp with Oats Recipe

| Ingredient | Amount (wt %) |
|---|---|
| Rice Flour | 49.45 |
| Partially Defatted Flaxseed | 10.00 |
| Hemp Protein Powder | 10.00 |
| Oat Flour | 30.00 |
| Sea Salt | 00.50 |
| Extract of Rosemary | 00.05 |

Analysis of the composition in Table 4 revealed a product having 15.3% protein, 9.8% fibre and 5.1% fat content. In accordance with the EC REGULATION No. 1924/2006 OF THE EUROPEAN PARLIAMENT on nutrition and health claims made on foods, the Flaxseed Crisp of Table 3 qualifies for the following claims: High in Fibre, a Source of Protein, Low in Sugar and a Source of Omega-3 Fatty Acids.

TABLE 5
Analysis of the Flaxseed Crisp in Table
2 that has been stored for 2 years

| Analyte | Amount | Unit |
|---|---|---|
| Omega-3 | 2.29 | g/100 g |
| Free Fatty Acid | 0.3 | % |
| Peroxide Value | 144* | mEq/kg fat |
| Peroxide Value | 7.06** | mEq/kg product |

*72 millimoles/kg of fat;
**3.53 millimoles/kg product

The PV mEq/kg fat and PV mEq/kg product presented in Table 5 are the results for the flaxseed crisps of Table 2. The PV mEq/kg fat reflects the PV per kg of the fat in the flaxseed crisp, whereas the PV mEq/kg product reflects the PV per kg of the entire product. As per Table 5, the Omega-3 Fatty Acids are still present after storage for 2 years, thus indicating a product with a superior shelf life period. As flaxseed oil is generally unstable over shelf life due to the nature of the high amount of polyunsaturated fatty acids, the chemical analysis verifies the compositional stability of the product.

Table 2 shows the ingredient and chemical composition of a crisp made with 60% partially defatted flaxseed. This has the highest fibre content of the compositions presented above and it also qualifies as being high in protein and high in omega-3. As an inclusion in a ready-to-eat cereal, this product would enhance the nutritional profile by contributing significant amounts of protein, fibre and omega-3.

The analysis of Table 3 shows the effect of adding pea protein isolate (85%) to the formulation at a level of 19.45 wt %. The addition of pea protein isolate elevates the protein content In Finished Product (IFP) to 35%, which means this product could be used as an inclusion ingredient to increase the protein level in a ready-to-eat cereal, as well as contributing significant amounts of fibre and omega-3. The product outlined in Table 3 has retained its crisp-like texture, without having any graininess or a gritty mouthfeel with this amount of protein in the crisp.

Table 4 outlines a product that includes oats along with flaxseed and hempseed. The crisp of Table 4 can be used as a superior, textured cereal which can be eaten on its own and contributes not only protein, fibre and omega 3 but also beta-glucans from the oats. The benefit of beta-glucans is that they have been shown to decrease levels of saturated fat in the blood, have an effect on blood glucose regulation (reducing the risk of heart disease) and may also have some immunomodulatory properties.

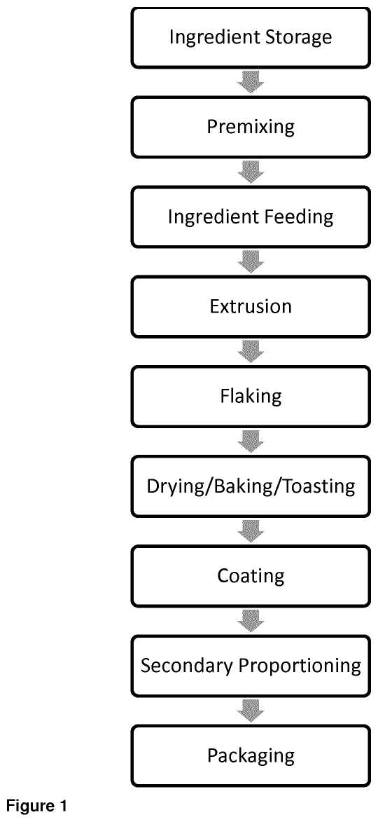

Turning now to FIG. 1, the extruded textured food product is made, but not limited to this process and equipment type, by using a twin-screw extruder via the following steps:
Ingredients are kept in a cool, dark place prior to use. In a premixing step the respective amounts of ingredients are dry blended prior to entering the extruder to ensure homogeneous mixture of ingredients.
The preblended dry ingredients, along with ambient water, are fed into the extruder at a set speed.
Extrusion takes place at a temperature of between 100-170° C., for a dwell time in an extrusion barrel of between 20 and 40 seconds.
The warm extruded pieces are passed between 2 rollers to achieve a flake-type or oval shape, having a length of between 4-5 mm and a diameter of about 3 mm (flaking). The shaped pieces are then dried to a final moisture content of 2-5% in a static fan-assisted oven, at a temperature range of 100-120° C.
An additional step, which is optional, is where the extruded crisp product is coated with either malt syrup, date syrup or honey, or a combination thereof, following cooling.

There is also an option to create a product that is a mixture of the extruded crisp with other particular ingredients such as seeds, nuts, dried fruits or vegetables etc. (secondary proportioning). The additional ingredients can be added either to the first step of the process where the core ingredients of the product are dry-blended together or after the product is dried following shaping.

The finished extruded crisp product is packaged for storage. The packaging can be in consumer units or bulk quantities bag-in-box. The packaging material for consumer units is preferably a metalized polyester material, which is hermetically sealed using a modified atmosphere. Various modified atmospheres can be used, such as, for example, carbon dioxide, nitrogen and combinations thereof.

Using the recipes and methods described herein, textured, plant-based, extruded food products can be produced, which can be used either as cereals in their own right or as ingredients in conventional boxed cereal formulations. These extruded food products are wheat-free, low in sugars, provide a source of protein and are high in fibre and in omega-3 fatty acids. They have a much higher nutritive value than conventional extruded cereal products. The product of the invention is provided to meet the demand for more nutritious breakfast and snack offerings, while still maintaining the crunchy texture that consumers like. The food product is non-genetically modified (non-GM), allergen free, plant based (a more sustainable protein source), and incorporates other highly nutritious ingredients with nutraceutical effects such as turmeric, wheatgrass, chlorella, spirulina, etc., and has no added sugar. Defatted flaxseed has excellent demulcent properties due to its very high soluble and insoluble fibre content, which makes defatted flaxseed much gentler on the digestive system than wheat fibre.

Extruded, direct expanded food products, such as those of the prior art documents discussed above, are typically high starch, crispy, crunchy or puffy and light foods that come in a variety of shapes and sizes depending on the die to be used spheres, sticks, pillows, animals, cartoon characters stars, rings, curls, chips, etc. They are generally textured and often coated with sugars or syrups or savoury coatings to add flavour and further texture to make them palatable. They are eaten at all times of the day and can be sweet or savoury. They are normally very high in starch and of low nutritional value and are produced via extrusion systems. The product of the claimed invention, though it is direct expanded, is not high in starch but is high in protein, fibre and omega 3 fatty acids, thus providing a far superior nutritional end product.

In the specification, the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail.

1. A textured crisp comprising at least one partially defatted oil seed, a gluten-free, high-starch flour, and an antioxidant.

2. The textured crisp of claim 1, wherein the at least one partially defatted oil seed is selected from flaxseed, hemp seed, pumpkin seed, sunflower seed, chia seed or a combination thereof.

3. The textured crisp of claim 1, wherein the at least one partially defatted oil seed is in powder form.

4. The textured crisp of claim 1, wherein the flour is selected from rice flour, lentil flour, potato flour, cornflour, tapioca flour, coconut flour, oat flour or a combination thereof.

5. The textured crisp of claim 1, wherein the antioxidant is selected from mixed tocopherols, cherry extract, vitamin C, acerola (Malpighia emarginata) extract, green tea extract, sage extract, ascorbyl palmitate, 3,5,4′-trihydroxy-trans-stilbene, Mentha spicate extract, turmeric extract and combinations thereof.

6. The textured crisp of claim 1, further comprising flavouring, starches, honey, date syrup, raw cane syrup, brown rice syrup. agave syrup, natural sugar replacers, inulin, steviol glycosides, monk fruit, vitamins, minerals, chlorella, spirulina, wheatgrass, barley grass, alfalfa, maca, cocoa, turmeric, herbs and spices and their extracts, natural colouring, botanicals, a freeze-dried component, dried fruit, vegetables, or a combination thereof.

7. The textured crisp as claimed in claim 1 further comprising a vitamin, in which the vitamins are selected from vitamins A, B, B1, B2, B6, B12, C, D, E, or K, Niacin, Pantothenic acid, Folic acid, Biotin, or combinations thereof.

8. The textured crisp as claimed in claim 1 further comprising a mineral, in which the mineral is selected from Calcium, Magnesium, Iron, Copper, Iodine, Zinc, Manganese, Potassium, Selenium, Chromium, Molybdenum, Phosphorus, or combinations thereof.

9. The textured crisp according to claim 1 further comprising a freeze-dried component, in which the freeze-dried component is a fruit or a material derived from a fruit such as strawberry, apple, orange, apricot, grape, peach, pear, berries, mango, melon, banana, citrus fruits, or a combination thereof; or a vegetable or product made from a vegetable including asparagus, pea pods, peas, broccoli, cauliflower, mixed vegetables, yellow red or green peppers, lotus fruit, celery, garlic, onion, lettuce, carrot, potato, corn, or a combination thereof.

10. (canceled)

11. The textured crisp of claim 1 wherein the at least one partially defatted oil seed is at a concentration of 5-65 wt % (dry weight).

12. The textured crisp of claim 1 wherein the at least one antioxidant is at a concentration of at least 0.01-0.1 wt % (dry weight).

13. The textured crisp of claim 1 having 5-40 wt % protein, 10-30 wt % fibre and 1-10 wt % alpha-linolenic acid.

14. A textured crisp according to claim 1, comprising rice flour, partially defatted flaxseed and rosemary extract.

15. A textured crisp of claim 1 comprising 39.95 wt % starch, 60 wt % partially defatted flaxseed, and 0.05 wt % rosemary extract.

16. The textured crisp according to claim 1, further coated with honey, malt syrup or date syrup.

17. A textured crisp of claim 1 comprising 30 wt % starch, 50 wt % partially defatted flaxseed, 19.45% pea protein isolate 85%, 0.5 wt % salt, and 0.05 wt % rosemary extract.

18. (canceled)

19. A textured crisp of claim 1 comprising 49.45 wt % starch, 10 wt % partially defatted flaxseed, 10 wt % hemp protein power, 30% oat flour, 0.50 wt % salt and 0.05 wt % rosemary extract.

20-21. (canceled)

22. The textured crisp as claimed in claim 1 having 1-10 wt % alpha-linoleic acid.

23. (canceled)

24. A method of producing a textured crisp comprising at least one partially defatted oil seed, a gluten-free, high-starch flour, and an antioxidant, the method comprising the steps of: premixing and dry blending ingredients being used; adding the premixed ingredients to a water stream being fed into an extruder; extruding the textured crisp at a temperature of between 100-170° C.; passing the extruded textured crisp between a pair of rollers to shape the textured crisp; and drying the shaped textured crisp in an oven at a temperature of between 100-120° C.

25. A method of claim 24, in which the extruded, dried and shaped textured crisp is further coated with a syrup or honey following cooling.

26-29. (canceled)

30. The textured crisp of claim 2, wherein the at least one partially defatted oil seed is in powder form.
